(19) United States
(12) Patent Application Publication
(10) Pub. No.: US 2008/0138758 A1
(43) Pub. Date: Jun. 12, 2008

(54) Brackets

(76) Inventor: Clemens Fricke, Bochum (DE)

Correspondence Address: COLLARD & ROE, P.C., 1077 NORTHERN BOULEVARD, ROSLYN, NY, 11576, US

(21) Appl. No.: 11/919,289

(22) PCT Filed: Apr. 11, 2004
(86) PCT No.: PCT/EP2004/006286

§ 371 Date: Oct. 25, 2007

(51) Int. Cl. A61C 7/14

(52) U.S. Cl. 433/10; 29/896.11

(57) ABSTRACT

The invention relates to a bracket for fixing to the interior or exterior face of a tooth, the bracket having a base, which lies against the tooth and in which a slot is configured to receive a wire bow. The slot runs essentially perpendicularly in the oral cavity, thus retaining the wire bow, which exerts forces and torques in an essentially horizontal direction, in an optimum position in the slot. The overall form of the inventive brackets is significantly rounder than brackets in prior art and the brackets are thus much more comfortable for the patient to wear. The invention also relates to a method, according to which the form of the brackets is individually adapted to each tooth of a patient, in order to optimize the displacement of the dental bow into its ideal position and the fixing of the brackets to the tooth.

The invention relates to brackets for attachment to the interior face or exterior face of the teeth, having a slot for accommodation of a wire bow, whereby the wire bow connects the teeth by way of the brackets, and exerts forces and torques in order to bring the teeth into a final position intended by the orthodontist, which comes as close as possible to the ideal position

In many people, the position of the teeth deviates from the ideal position. Optimization of the position of the teeth is desirable for the persons affected, not only for esthetic reasons, but also for medical reasons. For example, an incorrect position of the teeth can lead to a large number of problems in the sector of the stomatognathic system. Particularly in the case of severe deviations of the teeth from the ideal position, orthodontic treatment is almost unavoidable, in order to prevent sequential damage.

In addition to removable retainers, fixed apparatuses are used in this connection. Such fixed orthodontic apparatuses generally comprise so-called brackets that can be permanently affixed both buccally, on the exterior face of the teeth, and lingually, on the interior face of the teeth, for the time of the treatment. They serve for the fixation of wire bows that exert corrective forces and torques on the teeth, in order to bring them into their final position, in the final analysis. The forces are based on elastic deformation. Ideally, this elastic deformation is canceled out when the teeth are in their final position, so that no further forces are acting on them. The wire bow usually has a rectangular or round cross-section, and runs through slits provided in the brackets, which are referred to as “slots.” The cross-section of the slots is adapted to the wire bows they are intended to accommodate, i.e. rectangular. The teeth are connected with one another by way of the wire bows fixed in place in the slots. The use of such brackets as part of a fixed apparatus plays a large role particularly in the treatment of adults, which is increasingly gaining in importance.

Conventional brackets from the state of the art are essentially rectangular and have a total of four projections, whereby two of these projections, in each instance, are disposed lying opposite one another, in such a manner that a gap is situated between them, through which the wire bow can run. The two gaps situated between the pairs of projections described, together, form the slot. Accordingly, the slot runs essentially horizontally in the patient's mouth. In order to permanently fix the wire bow that runs through the slot in place, additional means are therefore required. Classically, these are elastic bands or wires that are attached to the aforementioned projections. In the meantime, however, brackets having various tilting mechanisms for fixing the wire bows in place have also become known.

It is a disadvantage of this state of the art that the slots run horizontally, so that the preshaped wire bows that run through the slots have the tendency, in the lingual technique, to slip out of the slots. Accordingly, particularly great care is necessary when fixing the wire bows in place in the slots. For another thing, because of the relatively edgy shape of the brackets, with a total of four projections that can have additional corners for attaching an elastic band, the wearing comfort for the patient is restricted to a not insignificant extent.

Proceeding from this state of the art, the task therefore presents itself of making available brackets as well as a method for the production of the brackets according to the invention, in which wearing comfort is clearly increased as compared with brackets from the state of the art, and in which secure fixation of the wire bows is possible even using the lingual technique.

This task is accomplished, according to the invention, by means of a bracket for attachment to an interior face or exterior face of the teeth, having a slot for accommodating a wire bow, and a base that rests against the interior face or exterior face of the teeth, whereby the slot is let into the base and runs essentially perpendicular in the oral cavity.

In this connection, essentially perpendicular means essentially perpendicular to the spatial axis, i.e. the slot runs almost parallel to the tooth surface. The angle between the vertical spatial axis and the slot can amount to −20 to +20°.

Since the forces brought about by the wire bow act essentially horizontally, the wire bow that runs through the slots no longer has a tendency to slip out of the slots. Accordingly, the fixation of the wire bow in the slots is also less complicated and only requires light elastic bands. Because it is possible to do without additional means of fixation, the wearing comfort is also further increased.

The bracket according to the invention has a clearly rounder shape, on the whole, with fewer edges, than a bracket known from the state of the art, since here, it is possible to do without the formation of a total of four projections between which the slot runs. This improved shape is clearly detectable for the patient, when he/she touches the brackets with his/her tongue, so that the wearing comfort is increased.

The bracket according to the invention not only does without the corners and edges that occur in the case of conventional brackets, because of the projections, but also advantageously has a base having a rounded surface. In particular, the base can have the shape of a teardrop that covers the interior surface or exterior surface of the tooth. In contrast to this, the base surface in the case of brackets from the state of the art is essentially rectangular. The basis of the bracket according to the invention, with a rounded surface, surrounds large areas of the interior face or exterior face of the teeth, on which the brackets are attached, and this not only increases the wearing comfort because of the rounding, but also additionally improves the adhesion of the brackets on the teeth. Typically, the base covers a major portion of the area (e.g. ≧60%) of the interior face or exterior face of the teeth. The risk of a bracket breaking out, and the complications connected with this, are therefore clearly reduced according to the invention, in comparison with the state of the art, in which the brackets cover only comparatively small regions of the tooth surface.

It is practical if the slot is let into the side of the bracket that faces the crown, which side is broader, in the case of the configuration in teardrop shape, in comparison with the side that faces the root. There is therefore sufficient space for the slot, without the adjacent regions of the bracket becoming too narrow, so that they no longer have sufficient resistance to the stresses that occur. An overly narrow configuration of the regions of the bracket adjacent to the slot and therefore also adjacent to the inserted wire bow would otherwise bring with it the risk that the region of the bracket might break off because of the forces that occur, and the wire bow would come loose. The configuration of the slot in the bracket on the crown side furthermore demonstrates the advantage of easier accessibility for the treating orthodontist, and this simplifies the insertion of the wire bow, which might have to take place repeatedly over the course of orthodontic treatment.

Furthermore, a slot on the side of the bracket that faces the crown is also advantageous because in this way, greater torques can be exerted on the tooth connected with the bracket, by the wire bow, on the basis of the lever effect. Since the brackets according to the invention cover large regions of the tooth surface, for practical reasons, there is also particularly large freedom of movement for positioning of the slot, so that greater torques can be achieved than in the case of conventional brackets having a small base area and a slot that is situated in the middle of the bracket.

The brackets according to the invention demonstrate particular advantages in the so-called lingual technique, in which the brackets are attached lingually, i.e. on the tongue side, on the interior face of the teeth. The lingual technique is particularly advantageous from an esthetic aspect, since brackets affixed lingually are not visible from the outside. Particularly in the treatment of adults, this is considered to be a great advantage by many patients, since, wearing orthodontic appliances is less socially acceptable here than in the case of adolescents. This frequently prevents adults from having the position of the teeth corrected, which is desirable from a medical point of view.

The bracket according to the invention is particularly well suited for the lingual technique, since brackets applied lingually are more exposed to contact with the tongue than those applied buccally. Accordingly, the shape of the brackets is also “felt” more strongly with the tongue, so that the rounding of the bracket and therefore the increase in wearing comfort have particularly great significance here.

It is provided to individually adapt the shape of the brackets and thereby also the shape of the base to the teeth, so that the brackets can be clearly positioned on every tooth. This makes it possible to do without the transfer aids usually used for positioning brackets from the state of the art. Such aids are necessary because the bracket shape, particularly the base area, is standardized and not adapted to the individual tooth shape of the patient and/or because no clear positioning can be achieved in the usual brackets, due to the small area of the base.

Aside from the individual adaptation of the shape of the brackets to the interior face or exterior face of the teeth, the location, the angle of incline, and the depth of the slot are also supposed to be individually adapted for each tooth, whereby the progression of the slots in the individual brackets and therefore also the progression of the wire bow laid through the slots is adapted to the optimized shape of the dental arc after treatment.

In particular, the brackets according to the invention are also supposed to allow the exertion of the most optimal torques on the tooth connected with the bracket. Since, in the case of conventional brackets, the slot is formed as an interstice between the projections situated on the bracket, which slot is situated in the middle of the bracket, and the brackets have a standardized base shape, the slot and therefore also the wire bow cannot be fixed in place on a tooth in any desired position, so that the effective lever arm might not be optimal, under some circumstances. In contrast to this, the individually adapted brackets according to the invention allow selecting the surface of the base and the location of the slot in such a manner that an optimal torque is exerted on the tooth. In the case of a great distance of the slot, and therefore also of the wire bow passed through it, from the jaw, the torque exerted is particularly great, for example.

Since it is provided to individually adapt the brackets according to the invention to each individual tooth of the patient, it is practical to mill the brackets under computer control; this, of course, also requires the use of a millable material. Here, zirconium oxide as a ceramic material is particularly advantageous, since zirconium oxide is tooth-colored and accordingly not noticeable. Such tooth-colored, non-noticeable brackets are desirable for many people, for esthetic reasons. While ceramic materials are already in use in orthodontia, they are usually cast and not milled. Alternatively, however, the brackets according to the invention can also be produced from a metallic material such as titanium, or a plastic.

In the latter case, the brackets can be obtained from a monomer bath, for example by means of polymerization, for example using radiation. Also, a ceramic mass (with a curable plastic as a binder) can be solidified in the desired shape by means of radiation.

The brackets according to the invention can have a hook proceeding from the base, which serves as an attachment point for ligatures or additional elements for providing forces and torques. In particular, the hook can bring about retention of the wire bow in the slot, in combination with a ligature attached to it. In this connection, an additional slot can lie between hook and base, to fix the ligature in place. It is advantageous if the hook is also configured to be rounded off.

For the case that an intrusive tooth movement, i.e. driving the tooth deeper into the jaw, is required as part of the orthodontic treatment, the bracket can be provided with a bite-down plateau. This bite-down plateau represents a flattened region of the bracket on the crown side, which is exposed for contact with the corresponding teeth of the opposite jaw, or with aids affixed to these teeth. In this way, a force is exerted on the bracket and thereby also on the tooth connected with it, by the teeth of the opposite jaw, within the framework of normal chewing and mouth-closing movements, which tooth is intrusively moved farther into the jaw over time. In the case of lingual attachment of the brackets, such bite-down plateaus are particularly used for maxillary front teeth.

As already mentioned, it is advantageous to individualize the orthodontic treatment for individual patients. In this connection, the individual brackets are supposed to be shaped in such a manner that all of the data for bringing the teeth into the planned final position are already contained in them. In classical orthodontia, standardized brackets are usually used, which merely have differences for the different types of teeth, but do not take the special situations of the tooth of each individual patient into consideration. Holding of the wire bow and therefore the forces and torques that act on the dental arcs are therefore not optimized, but rather require constant inspection and, if necessary, correction by the treating orthodontist. The treatment becomes all the more complicated since the orthodontist must check the progress of the treatment at relatively short time intervals, and it frequently takes longer, as well.

A method for the production of individualized brackets has already been disclosed in EP 0 667 753 B1, in which the anatomical shapes in the mouth of the patient are measured and an ideal dental arc shape is derived, on the basis of which the shape of the brackets and of the wire bow are established. Subsequently, the individual orthodontic apparatus is produced with the previously designed configuration, whereby in particular, a code that can be read by a CNC machine is used to control the production system.

In this connection, however, brackets that are conventional with regard to their base shape are used, and slots are milled into standard brackets that do not have a slot, at the calculated angle and in the calculated depth. The brackets produced in this manner have the disadvantages of the state of the art as already stated above, particularly the low wearing comfort and the tendency of the wire bow to slip out of the slots, and furthermore, they cannot be positioned on the tooth without a transfer aid, because their base is not completely individualized.

The brackets according to the invention, in contrast, have a clearly different shape than those from the state of the art, and furthermore are also supposed to have an individualized base, in particular, so that positioning on the tooth is possible without any transfer aid. The method for production of the brackets therefore advantageously comprises the following steps:

First, the shape of the dental arc before the treatment is scanned in; this can take place either in the patient's mouth or using a model of the dental arc that was produced. Subsequently, a simulation of the treatment goal with regard to functional aspects of the stomatognathic system is carried out. This means, in the final analysis, virtual optimization of the dental arc position, with the patient's teeth in the final position, which corresponds to manually creating a setup according to the state of the art. In this connection, a computer with software provided for this purpose is used. In comparison with the manual creation of a setup, however, more aspects can be taken into consideration in the computer simulation, thereby putting the treatment as a whole on a broader scientific basis, while conventional treatment is more clearly marked by the wealth of experience of the treating orthodontist.

On the basis of the simulation of the treatment goal that has been carried out, the shape of the brackets and of the wire bow is subsequently calculated and established, once again using suitable software. In this connection, the forces and torques that act on the teeth, in particular, are taken into consideration. The data generated in this manner serve for computer-controlled milling of the brackets.

Alternatively, the setup can also be produced manually, in conventional manner, before the setup produced in this manner is scanned, in order to generate the required data for simulation of the bracket and wire bow shape, and subsequently to carry out the computer-controlled milling of the brackets.

Further orthodontic treatment provides for attaching the brackets according to the invention to the interior or exterior faces of the teeth, by way of a conventional acid etching technique or also by means of the use of a glass ionomer cement, whereby light-curing is carried out, and for passing the wire bow through the slots. The wire bow is fixed in place in the individual slots by means of a ligature. For the remainder, the treatment takes place in classical orthodontic manner.

The corresponding software for carrying out a virtual setup and for simulation of the optimal bracket and wire bow shapes essentially corresponds to software as it is used for CAD and CAM methods. From the calculations, the computer generates a code that can be read by a CNC machine, to control the production system.

For scanning, a laser is preferably used, but the use of ultrasound scanners, video imaging, mechanical scanning, or other image generation apparatuses, is also possible. In this connection, the scanner, particularly the laser, should be such that it can detect the structure of the teeth as precisely as possible, whereby in particular, undercuts, etc., are also significant, in order to adapt the shape of the base of the brackets as precisely as possible to the tooth surface, for the purpose of optimal positionability.

Aside from optimization of the adhesion of the brackets to the tooth surface, the simulation of the bracket shape also serves to establish the angles and depth of the slots let into the brackets. These slots are adapted to the optimal shape of the dental arc after the treatment, which is also simulated. An orthodontic treatment that is based on the brackets produced according to the invention therefore leads to the optimal dental arc shape in more targeted manner than was possible until now. This is all the more true since it is possible, using the method described, to individually establish the shape of the brackets for each individual tooth.

The invention will be illustrated using the attached drawings.

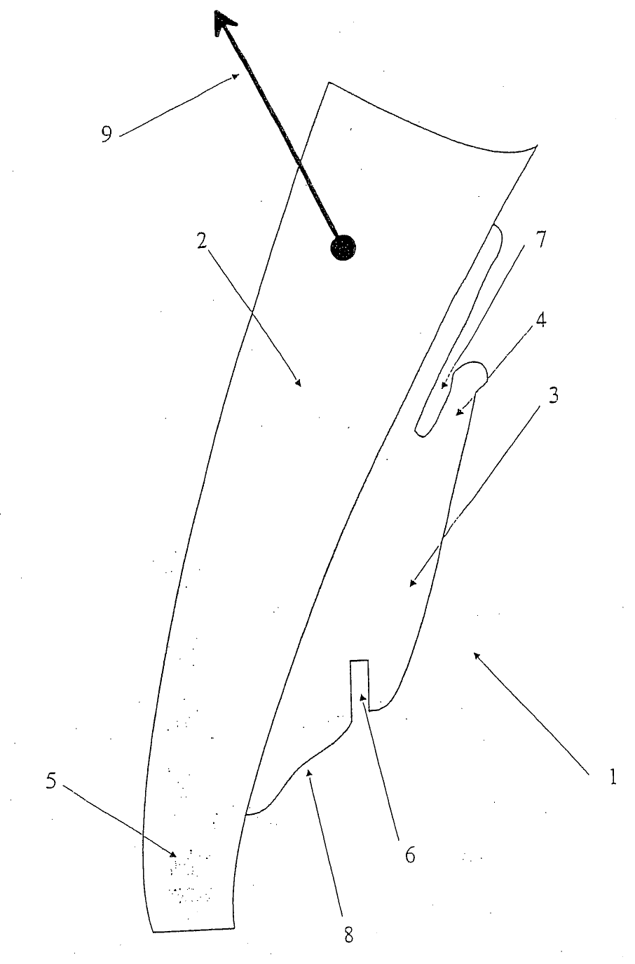

FIG. 1: shows a bracket according to the invention, which is attached to a tooth, in a side view.

The bracket according to the invention, which is provided, as a whole, with the reference symbol 1, is attached lingually to the interior face of the tooth 2, which is a front tooth of the upper jaw. Attachment of the bracket 1 to a tooth 2 can take place by way of a conventional acid etching technique. The bracket 1 is composed of a base 3 and a hook 4 that proceeds from the base 3, whereby a slot 6 is let into the base 3, towards the crown 5. The slot 6 serves to accommodate the wire bow and has a rectangular cross-section, like the latter. The base 3 has a teardrop shape, overall, and is broader on the crown side than at the end that faces the root. Towards the root, the base 3 runs out, narrowing in cross-section. On the side of the crown 5, on the other hand, the base is broad enough in cross-section so that it can easily accommodate a slot 6, without the regions adjacent to the slot 6 becoming too fragile because of the low material cross-section. On the root side, a hook 4 proceeds from the base, so that an additional slot 7 is formed, which serves to fix a ligature in place to secure the wire bow in the slot 6.

The bracket 1 furthermore has a flattened region on the side of the crown 5 of the tooth 2, which represents a bite-down plateau 8. This serves for contact with the corresponding teeth of the opposite jaw or with aids affixed to these teeth. In this manner, a force in the direction of the arrow 9 is formed, which intrusively moves the tooth 2 deeper into the jaw over time.

1. Bracket for attachment to an interior face or exterior face of the teeth, having a slot (6) for accommodating a wire bow, whereby the bracket (1) has a base (3) that rests against the interior face or exterior face of the teeth, wherein the slot (6) is let into the base (3) and runs essentially perpendicular in the oral cavity.

2. Bracket according to claim 1, wherein the base (3) has a rounded surface.

3. Bracket according to claim 1 wherein the base (3) is configured in teardrop shape.

4. Bracket according to claim 1, wherein the base (3) covers an area ≧60% of the interior face or exterior face of the teeth.

5. Bracket according to claim 1, wherein the slot (6) is let into the side of the base (3) that faces towards the crown (5) of the tooth (2).

6. Bracket according to claim 1, wherein the bracket (1) is lingually attached to the tooth (2).

7. Bracket according to claim 1, wherein the shape of the bracket (1) including the base (3) is individually established for each tooth (2).

8. Bracket according to claim 1, wherein the bracket (1) can be positioned on the tooth (2) without a transfer aid.

9. Bracket according to claim 1, wherein the location, the angle of incline, and the depth of the slot (6) are individually adapted for each tooth (2), to the optimized shape of the dental arc after treatment.

10. Bracket according to claim 1, wherein the bracket (1) is produced from a millable material.

11. Bracket according to claim 10, wherein the bracket (1) consists entirely or partially of ceramic, preferably zirconium oxide.

12. Bracket according to claim 10, wherein the bracket (1) consists entirely or partially of titanium.

13. Bracket according to claim 10, wherein the bracket (1) consists entirely or partially of plastic.

14. Bracket according to claim 1, wherein the bracket (1) has a hook (4) that serves as an attachment point for ligatures for retention of the wire bow in the slot (6).

15. Bracket according to claim 1, wherein the bracket (1) has a bite-down plateau (8) that serves for contact with corresponding teeth of the opposite jaw.

16. Method for the production of a bracket (1) according to claim 1, having the following steps
a) Scanning of the dental arc before the treatment, in the patient's mouth or using a model of the dental arc,
b) Simulation of the treatment goal with regard to functional aspects of the stomatognathic system, using software intended for this purpose,
c) Determination of the shape of the brackets (1) and of the wire bow, on the basis of the simulation of the treatment goal that was carried out, using software intended for this purpose, and
d) Computer-controlled milling or polymerization of the brackets (1) in accordance with the shape previously established.

17. Method for the production of a bracket (1) according to claim 1, having the following steps
a) Manual production of a setup,
b) Scanning of the setup that was produced,
c) Determination of the shape of the brackets (1) and of the wire bow, on the basis of the setup that was carried out, using software intended for this purpose, and
d) Computer-controlled milling of the brackets (1) in accordance with the shape previously established.

18. Method according to claim 16, wherein a laser is used for scanning.

19. Method according to claim 16, wherein the slots (6) are let into the brackets (1) in such a manner that they are adapted to the optimized shape of the dental arc after treatment.

20. Method according to claim 16, wherein the shape of the brackets (1), including the base (3), is individually determined for each tooth (2).
